(19) United States
(12) Patent Application Publication
(10) Pub. No.: US 2002/0007287 A1
(43) Pub. Date: Jan. 17, 2002

(54) System and method for electronic archiving and retrieval of medical documents

(76) Inventors: Dietmar Straube, Erlangen (DE); Glen William Cook, Glen Allen, VA (US); Jacqueline Krubke, Uttenreuth (DE)

Correspondence Address: GREENBERG-TRAURIG, 1750 TYSONS BOULEVARD, 12TH FLOOR, MCLEAN, VA, 22102, US

(21) Appl. No.: 09/737,810

(22) Filed: Dec. 18, 2000

Related U.S. Application Data
(60) Provisional application No. 60/171,089, filed on Dec. 16, 1999.

(51) Int. Cl. G06F 17/60; G06F 17/30

(52) U.S. Cl. 705/3; 707/204; 707/10

(57) ABSTRACT

A system and method for redundantly storing documents, specifically medical records, both on a local computer and on a remote server. A copy of patient data is stored remotely in the event of system problems, and to allow access to patient data from multiple sites. Data is stored on the local computer to speed retrieval of the data at a later date. When data stored on the local computer is newer or the same age as data stored on the remote server, the data is not downloaded from the remote server. If the local data is older than the data on the remote server, the data is downloaded from the remote server. Data may be displayed and organized utilizing a customizable, hierarchical “tree view.” Data may include image files, text files, and information about the files, such as the patient with whom they are associated, the time they were entered into the system, the time of the patient's next appointment, and the like. The client software portion of the present invention may update automatically, or as a result of user interaction. News and other information of interest may be automatically displayed to a user through a connection to the Internet, or through integration with Email, accounting, scheduling, or other systems.

The present application claims the benefit of U.S. Provisional Patent Application Ser. No. 60/171,089, entitled “System and Method for Electronic Archiving and Retrieval of Medical Documents,” filed Dec. 16, 1999, the entire contents of which are incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The invention relates in general to electronic document delivery, and in particular to providing enhanced communication regarding various medical procedures between the patient and the physician.

2. Related Art

The power of a high-quality page layout on an inexpensive, portable medium like paper has not diminished since the advent of the internet. Most people still prefer reading documents on paper and appreciate the visual benefits of a properly laid-out page of text.

Although the Internet offers a quick, inexpensive, and easy method of delivering information, the currently available programming languages that support it are designed to deliver information to a monitor—not to paper. This means that typically a choice must be made between paper based and electronic document management techniques.

Paper based document management requires vast storage space and specialized filing systems, all of which must be managed by a person or group of people.

Traditional electronic document management systems improve over paper based systems by converting paper documents to electronic form. By creating electronic files, the physical storage and filing system management requirements are significantly reduced. In addition to the document itself, an electronic document management system may be provided to allow a user to store information about the document, known as metadata, in the database, thus allowing users to search for and retrieve documents.

### OBJECTS AND SUMMARY OF THE INVENTION

In its preferred embodiment, the present invention provides a system for electronic archiving and retrieval of medical documents which provides users with a graphical interface that may be used to store, organize, locate, and retrieve files. The present invention also improves upon the prior art through a standardized or proprietary markup language, such as Hypertext Markup Language (HTML), Standardized Generalized Markup Language (SGML), or extensible Markup Language (XML), to store the content of, and/or metadata about, a file. In addition, the present invention may use a standardized or proprietary stylesheet language, such as Cascading Style Sheets (CSS), extensible Stylesheet Language (XSL), or Portable Document Format (PDF), to store and retrieve page layout information. The invention also improves upon the prior art by storing data both locally and on a database server, thereby providing redundant storage and also making data available via the Internet. The present invention further improves upon the prior art by incorporating high-resolution images and streaming multimedia content to a user, even under low-bandwidth conditions.

Documents stored as part of the present invention may be organized through an underlying database, and information returned by the database may be displayed through a graphical interface. Through a graphical interface, document data can be organized based on several criteria, and an underlying organizational structure may be displayed through a “tree view”.

### BRIEF DESCRIPTION OF THE DRAWINGS

FIG. 1 illustrates a system overview of the present invention displaying the computers, servers, and databases used for accessing and delivering the medical records.

FIG. 2 illustrates the user interface used to access and edit information pertaining to each document stored in the present invention. FIG. 2 specifically illustrates a preview of a document as it would appear when printed, with the Bookmarks window enabled.

FIG. 3 illustrates the user interface used to access and edit information pertaining to each document stored in the present invention. FIG. 3 specifically illustrates a preview of a document as it would appear when printed, with the Bookmarks window enabled.

FIG. 4 illustrates the tree view navigation and other aspects of the user interface to the present invention.

FIG. 5 illustrates a user interface used to provide status information to users while the I10 local database is updated.

FIG. 6 illustrates the user interface used to access and edit information pertaining to each document stored in the present invention. FIG. 6 specifically illustrates an interface used to record notes and comments generated by a physician or other caregiver.

FIG. 7 illustrates a user interface used to access and edit information pertaining to each document stored in the present invention. FIG. 7 specifically illustrates adding and editing caregiver or physician information.

FIG. 8 illustrates another example of the user interface used to access and edit information pertaining to each document stored in the present invention. FIG. 2 specifically illustrates a preview of a document as it would appear when printed, with the Bookmarks window enabled.

FIG. 9 illustrates another example of the user interface used to access and edit information pertaining to each document stored in the present invention. FIG. 3 specifically illustrates a preview of a document as it would appear when printed, with the Bookmarks window enabled.

FIG. 10 illustrates another example of the tree view and other aspects of the user interface to the present invention, with the Bookmarks window enabled.

FIG. 11 illustrates another example of a user interface used to provide status information to users while the local database is updated.

FIG. 12 illustrates another example of the user interface used to access and edit information pertaining to each document stored in the present invention. FIG. 6 specifically illustrates an interface used to record notes and comments generated by a physician or other caregiver.

FIG. 13 illustrates another example of a user interface used to access and edit information pertaining to each document stored in the present invention. FIG. 7 specifically illustrates adding and editing caregiver or physician information.

### DETAILED DESCRIPTION OF THE PREFERRED EMBODIMENT

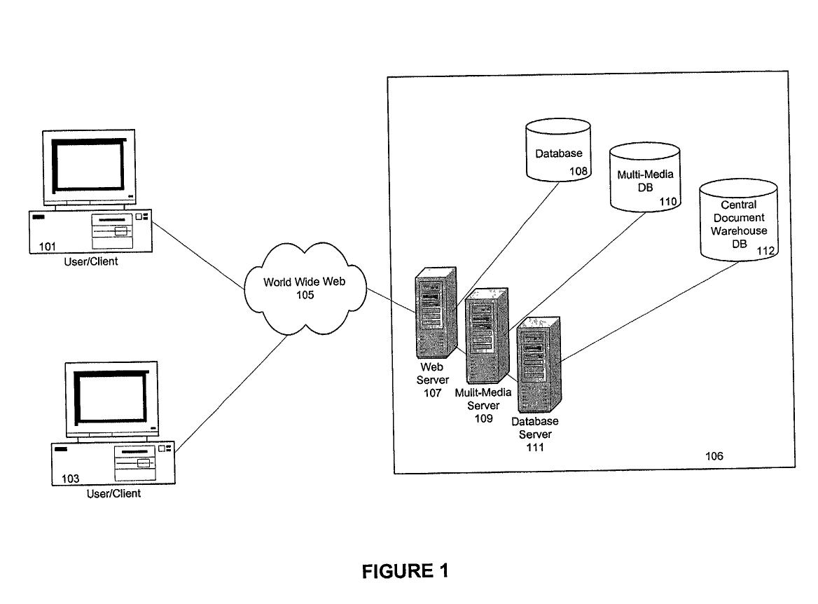

The present invention provides an electronic archiving and retrieval of medical documents system which allows users to store, organize, locate, and retrieve files through an interactive a graphical interface. The present invention may also provide redundant storage by storing data both locally and on a database server. The database server is accessible via the internet as will be described in conjunction with FIG. 1.

The present invention consists of a proprietary Internet browser for document transmission and retrieval capable of delivering the content contained within the system. This content may include numerous guides and procedures in a multitude of languages. Typically, the guides and procedures are authored by nationally prominent physicians and subsequently are legally and professionally edited and reviewed.

The user can decide between from four versions for implementation of the present invention. The first versions include a CD installed, internet maintained and administered desk top, single computer site. Another version is a CD installed, internet maintained and administered server version, multi-computer site.

In addition to the CD installed versions, the user can utilize the Application Service Provider (ASP) version for a stand alone business model or the ASP version for an OEM or integrated business model. The ASP versions seamlessly integrates the components of the present invention within the total information system sold by other vendors meeting the requirements of hospitals and or physician organizations.

All versions are complimented with a public web site system on which any individual user worldwide with Internet access can access medical procedure specific information in a multitude of languages. The content, information, medical guides, records, and procedures stored by the present invention can be delivered by the present invention or included as part of other healthcare web systems.

In a preferred embodiment, the present invention makes use of a client/server architecture as shown in FIG. 1. The client/server architecture includes personal computers 101, 103, which may be PC's, laptops, personal digital assistants, pagers, cell phone or other computerized devices, which are able to access the document retrieval system 100. The user, through an electronic device, such as a computer 101, 103, accesses the databases 108, 110, 112 through the World Wide Web 105 through web-server 107. The present invention, or system 100 may contain multiple servers, such as web-server 107, multimedia server 109, and database server 111.

The present invention includes a remote server system 106 which acts as a central document warehouse, as well as software run on a user's computer 101, 103 which acts as a “client”, providing an interface between a user and a central document warehouse.

A remote document warehouse system 100 may consist of a World Wide Web (WWW) server 107 (“web server”), a multi-media server 109, and a database server 111. Examples of World Wide Web servers 107 include Internet Information Server, published by Microsoft Corporation of Redmond, Washington, Netscape Enterprise Server, published by Netscape Corporation of Redondo, Calif., and Apache Server, published by The Apache Software Foundation of Lincoln, Nebr. Examples of database servers 111 include SQL Server, published by Microsoft, and Oracle, published by Oracle Corporation of Redwood Shores, Calif.

A web server 107 may be used to facilitate communications between client software running on a user's computer 101, 103, and a database server 111. A client 101, 103, can create a specially formatted instruction set, utilizing Standardized Query Language (“SQL”), Hypertext Transmission Protocol (“HTTP”), Secure Hypertext Transmission Protocol (“HTTPS”), and/or other similar protocols, to open a connection with a web server (utilizing HTTP's GET command or a similar command). Data sent utilizing HTTPS may he encrypted, thus providing a secure method of transmitting data between a client 101, 103 and a document warehouse 112.

With an open connection, such as through the World Wide Web 105, a client 101, 103 may request data from or ask to store data in a document warehouse database 112. When such a request is received, a web server 107 may pre-process the request, converting the request to a format used by a specific database server, or a request may be sent directly to a database server 111.

A request from a web server 107 to a database server 111 may take the form of a SQL query, Open Database Connectivity (“ODBC”) statement, Microsoft JET command, or a combination of these and/or other query languages. A database server 111 receiving a request can process that request, and may return data for display on a user's computer 101,103. Returned data can include query result sets, storage confirmation, and error codes.

When a web server 107 receives information from a database server 111, the information can be transmitted to a user's computer 101, 103. Transmission may be accomplished by keeping open the WWW connection 105 created by the client 101, 103 and returning the results through that connection, or results may be returned by pushing data to the client 101, 103. Client software running on a user's computer 101, 103 may take the form of a World Wide Web “browser”, such as Microsoft's Internet Explorer, or Netscape's Navigator; a custom application; or a hybrid design, incorporating a custom application and a web browser.

When a user enters information into the present invention, the client 101, 103 may store a copy of the information on the local computer 101, 103 as well as on the database server 111 or in one of the databases 108, 110, 112.

If a user requests information from a database server 111 and the result yields a large block of data, such as an image, the client software may first check for a local copy of the data. If a local copy exists, date and time stamps or other identifiers can be compared. If the identifier comparison shows that data stored in the data warehouse 112 is newer than that which is stored locally, the data is downloaded from the data warehouse 112. However, if the local copy has the same identifier or is newer than the copy on the database server 111, the local copy may be used, thus avoiding a lengthy download.

In addition to providing a customizable user interface, the present invention also improves upon the prior art through an infrastructure allowing components of the client portion of the present invention to be updated whenever newer versions are available. The client portion 101, 103, of the present invention can periodically communicate with the server portion 106, verifying that all components of the client are at the appropriate revision level. If a newer version of a component or components is available, the new version or versions may be automatically downloaded and installed, or a user may interact with the system, determining when any changes may be applied.

This same system or a similar system may also be used to deliver news and other information to a user. News may be generated by the present invention, or it may be generated at a local administrative level. Examples of news may include recently enacted legislation which may affect a user, updated billing or other requirements from healthcare or health insurance companies, reminders of overtime and other requirements, and other similar measures.

As a further improvement over the prior art, the present invention may create a unique number or other identifier that distinguishes a computer on which a document is created. Each document entered into the system on a computer contains a reference to this identifier. Files created on other computers may not be viewable unless authorization has been given for the viewing computer. Authorization may be specific to a file, or may include a range of computers. For example, one file entered into the system may restrict viewers to only those on the computer used to enter the file into the system. Another file may restrict viewing computers to all computers within an organizational unit. Another file may allow itself to be viewed by all computers within a hospital or system of hospitals.

The present invention also improves over the prior art by providing a user with not only graphics and text, but also multimedia content. Multimedia content deliverable to a desktop may include audio recordings and video recordings of patient sessions. The present invention may include a separate multimedia server 109 and multimedia database 110 for providing multimedia content, as seen in FIG. 1. The present invention may also provide a seamless and secure integration with existing database systems, such as accounting, E-mail, and scheduling systems. For example, scheduling changes may be presented to a user as part of the previously described news feature, and documents may be securely transmitted via an E-mail system.

In addition, the present invention stores data utilizing standardized markup and style sheet languages, which allows the present invention to properly render a document as it was meant to appear on paper each time it is printed. Storing data utilizing standardized markup and style sheet languages can allow the present invention to provide an alternative representation for display on a display device, such as a computer monitor, personal desktop assistant (PDA), pager, cell-phone, or other computerized device.

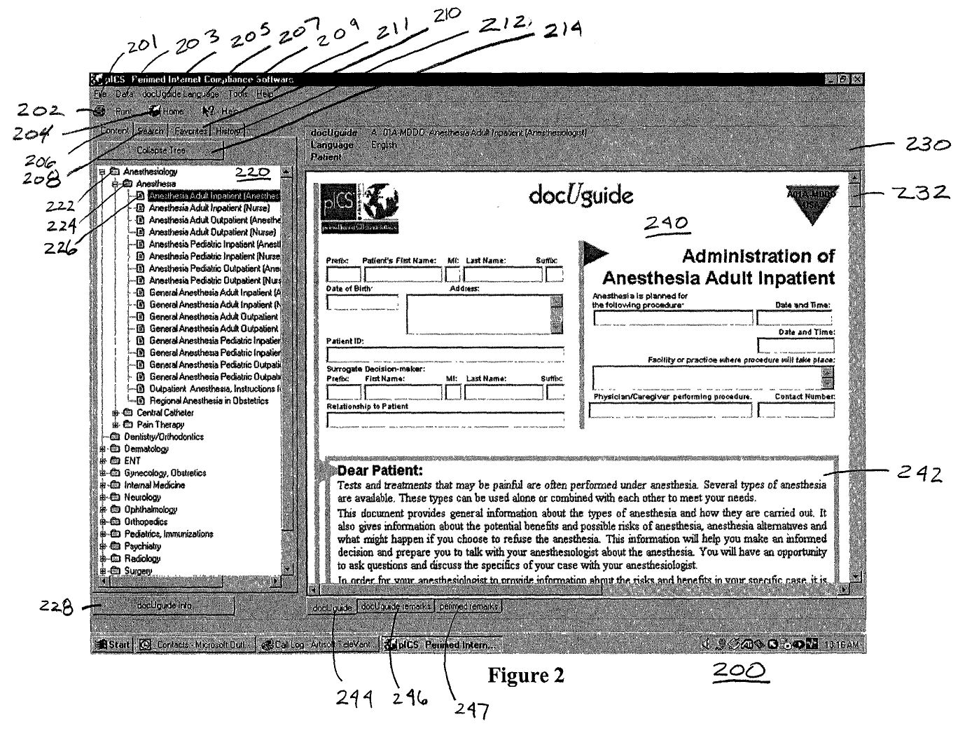

FIG. 2 illustrates an additional example of a user interface 200 which includes the Bookmarks window 220 available through the present invention. The Bookmarks window 220 enables the user to interact with the present invention to access various medical information and files stored within the system. The various features and functions of the user interface 200 include a files menu 201, and data menu 203, a docUguides menu 205, a Language menu 207, a Tools menu 209, and a help menu 211. The Bookmarks, as seen in window 220, allow users to quickly access files stored in the present invention.

In the presently preferred embodiment, the invention utilizes a tree view (“view”) navigation as its primary method of organizing and displaying documents, as seen in the Bookmarks window 220. A tree view navigation is a graphical representation of a hierarchical organizational scheme. A tree view can allow a user to combine multiple document types, such as images and text files, into a container (“folder”) for organizational purposes. In addition to individual files, a folder may also be used to hold other folders, thus providing a means of graphically organizing data stored in the present invention. A default set of views may be presented to a user when a user is initially given access to the system. However, users can customize a view or create their own views.

As shown in FIG. 2, the tree view depicted in Bookmarks window 220 includes various folders 222, 224. Each of these folders 222, 224, may contain various files, such as file 226. The ability to store various folders and files in a tree view allows the user to quickly and accurately access the files and data they are interested in viewing. The user may also collapse the tree view by selecting the “Collapse Tree” tab.

A user may create a custom view as a means to limit the data displayed to them to only the data in which they are interested. For example, a user may limit the data displayed to only those patients scheduled for operations on a given day. Tree views can also be used to illustrate an hierarchical structure based on multiple criteria, and each user may view a structure differently. For example, an administrator may prefer to organize documents by creating a folder for each department. Within each department, a folder may be created for various specialties, and within a specialty a folder may be created for each doctor working in that specialty. Within a doctor's folder, documents may be organized by patient.

Although an administrator may prefer to see documents organized by department, individual physicians or technicians may prefer to see documents organized in a calendar format, with a folder for each day and subfolders dividing the day, such as morning and afternoon, or folders for each hour. Organizing based on the day can allow a user to limit the documents displayed to only those which a user may need on a given day.

Individual settings (“views”) may be stored by a user of the present invention. The present invention may also allow a user to retrieve those settings later. Views may be created based on the contents of one or more data or metadata fields. A view may be created that only display files or folders based on specific criteria, such as, but not limited to, keywords, entry date, appointment date, or priority. Although a view can allow a user to create an organized, graphical representation of data stored in the present invention, any underlying data structure may not be affected by changes to a view.

In addition, the present invention has additional features and functions which pertain to individual files 226 which are accessed by the user. As can be seen in FIGS. 2 through 7, the user can select the appropriate medical information they want to view. As seen in FIG. 2, the user can select which files to view through the various files tabs which include Content 206, Search 208, Favorites 210, and History 212. The user can print the medical document, record or file using print button 202 and can go to the start or home page using the “Home” button 204. The file 226 selected by the user is highlighted in window 220 and indicated in title bar 230. FIG. 2 displays a medical document window 240 which displays the appropriate selected information from the selected file 226. The user can select which information to view regarding the selected file 226 by choosing between the viewing tabs which include the docUguide 244, docuguide remarks, and “perimed” remarks 247. The user can also view docUguide information by selecting tab 228 and can be shown patient specific information in window 242. The user can scan the document up and down for viewing the entire medical document file by choosing viewing bar 232.

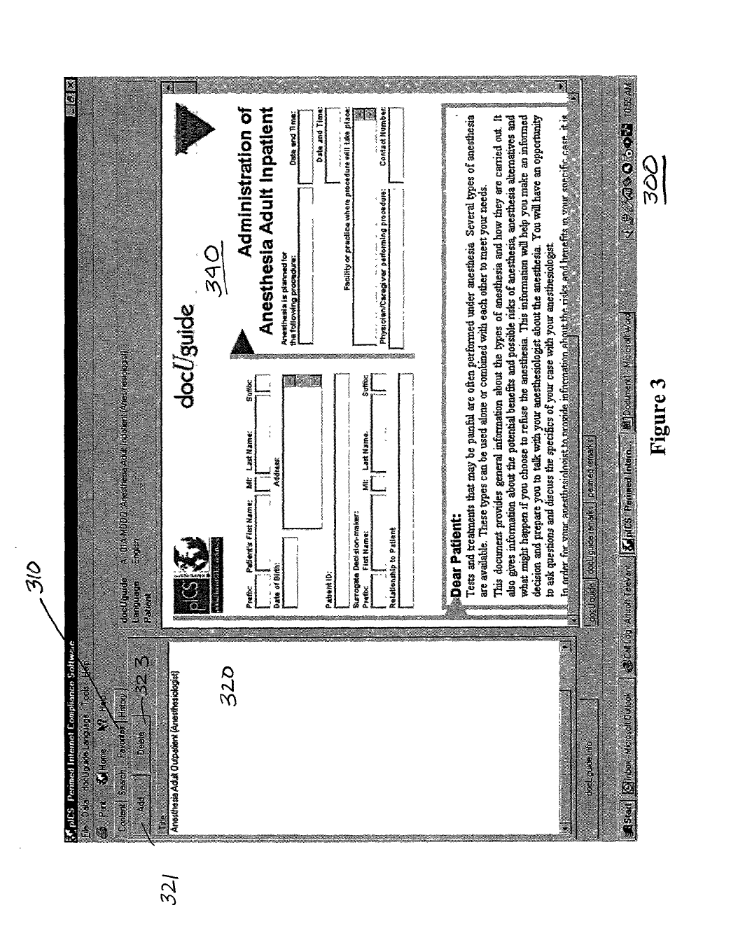

FIG. 3 contains the same screen capture as displayed in FIG. 2, except the screen capture 300 includes the additional window 320 which indicates medical record files which had been marked under the favorites tab 310. The medical document files can be added to the favorites list by use of bars 321 and 323. The medical file selected is still shown in window 340.

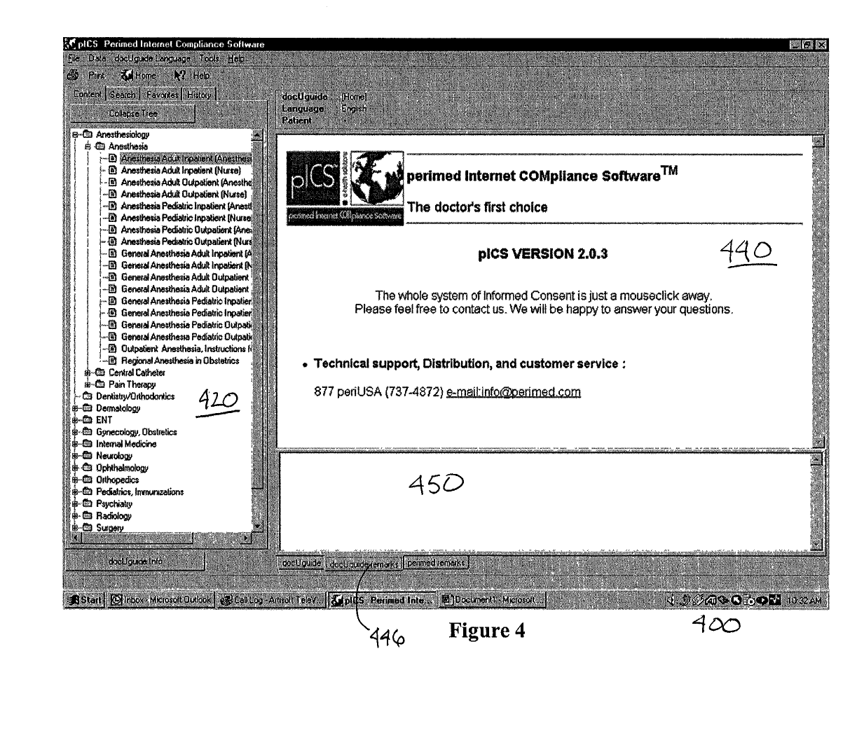

FIG. 4 represents a screen capture 400 indicating a home page 440 which is highlighted in the bookmark window 420 on the tree view, as previously described. The screen capture 400 also includes a remarks window 450 accessed by remarks tab 446.

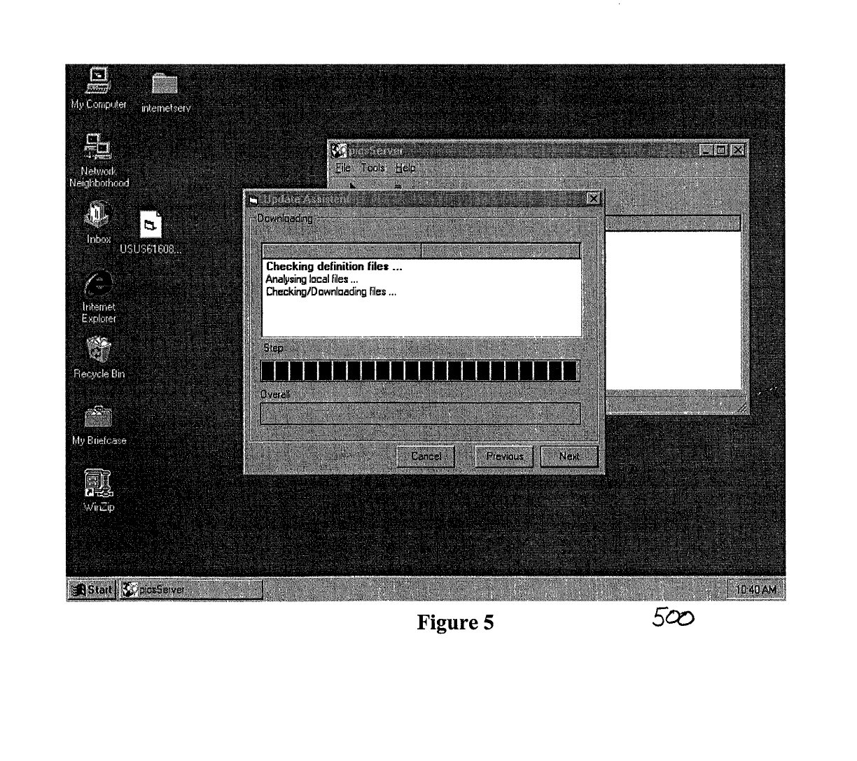

FIG. 5 illustrates a user interface screen 500 used to provide status information to users while the local database is updated. Data kept locally may be stored in a database or as part of the file.

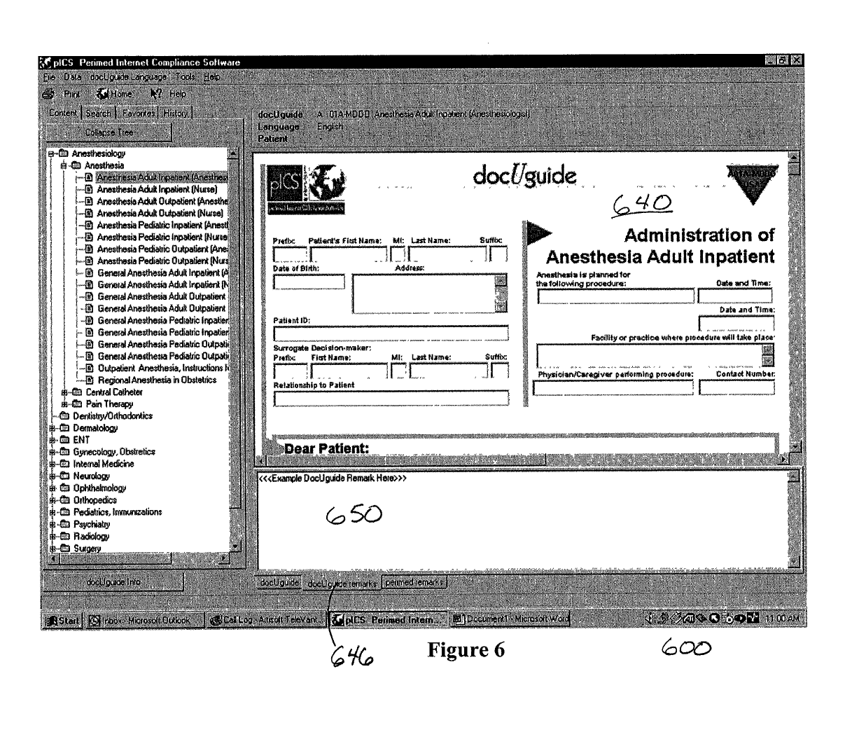

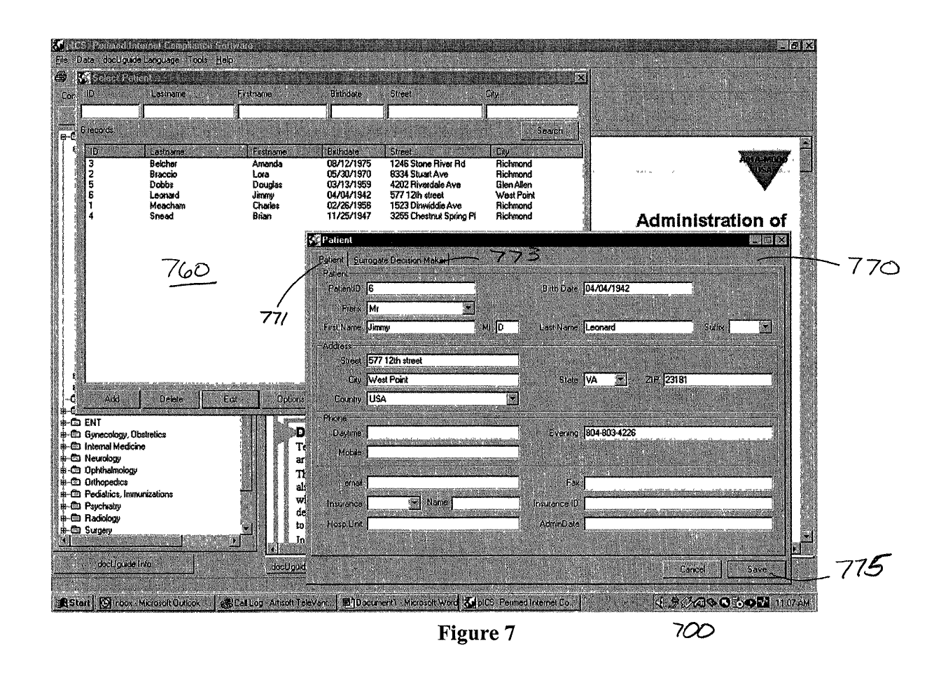

FIGS. 6 and 7 illustrate additional portions of a user interface available through the present invention. FIG. 6 illustrates an interface used to record notes and comments generated by a physician or other caregiver. As indicated in FIGS. 2 through 7, the user may select from the files 226, as seen in FIG. 2. Provided the user has proper access they will be able to add comments within the specific areas such as perimed remarks or docUguide remarks. Under the docUguide preferences tab 646 a user can review notes in window 650.

FIG. 7 depicts another user interface 700 where physicians have the ability to select a patient in window 760 and edit or change information about the patient using window 770. The physician, in window 770, may select to review or edit the patient information under the “Patient” tab 771 or review or edit under the “Surrogate Decision Maker” tab 773. All changes and modification can be saved using tab 775.

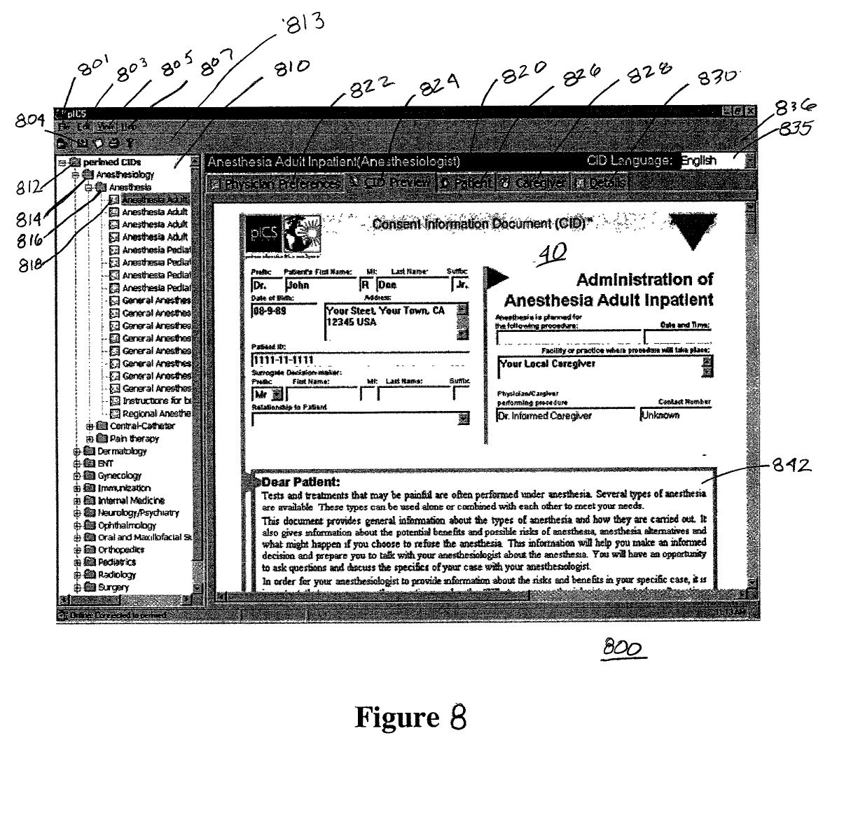

FIGS. 8 through 13 provide additional examples of various user interface pages for the user to access, review, edit and save medical documents, records and files. FIG. 8 illustrates an additional example of a user interface 800 which includes the Bookmarks window 810 available through the present invention. The Bookmarks window 810 enables the user to interact with the present invention to access various medical information and files stored within the system. The various features and functions of the user interface 800 include a files menu 801, and edit menu 803, a view menu 805, and a help menu 807. The Bookmarks, as seen in window 810, allow users to quickly access files stored in the present invention. The Bookmarks window 810 may be viewed or hidden by clicking the book icon 804 in the toolbar 836, or by choosing Bookmarks under the View menu 805.

Once again the invention may utilize a tree view (“view”) as its primary method of organizing and displaying documents, as seen in the Bookmarks window 810. The tree view allows a user to combine multiple document types into a container (“folder”) for organizational purposes as well as hold other folders, thus providing a means of graphically organizing data stored in the present invention. A default set of views may be presented to a user when a user is initially given access to the system. However, users can customize a view or create their own views.

As can be shown in FIG. 8, the tree view depicted in Bookmarks window 810 includes various folders 812, 814, 816. Each of these folders 812, 814, 816, may contain various files, such as 818. The ability to store various folders and files in a tree view allows the user to quickly and accurately access the files and data they are interested in viewing.

In addition, the present invention has additional features and functions which pertain to individual files 818 which are accessed by the user. As can be seen in FIGS. 8 through 13, the user can select the appropriate medical information they want to view. As seen in FIG. 8, the user can select between physician preferences 822, CID (Consent Information Document) preview 824, patient information 826, caregiver information 828, and details 830. The file 818 selected by the user is also highlighted and indicated in title bar 820. In addition, the user can select the language in which to view the information utilizing menu 835. FIG. 8 represents a screen shot 840 of information available under the CID preview 824 tab. The information contained in each tab may include notes to the patient as indicated in 842, as well as address patient information. The CID preview information can be used to verify and communicate patient consent for a medical procedure.

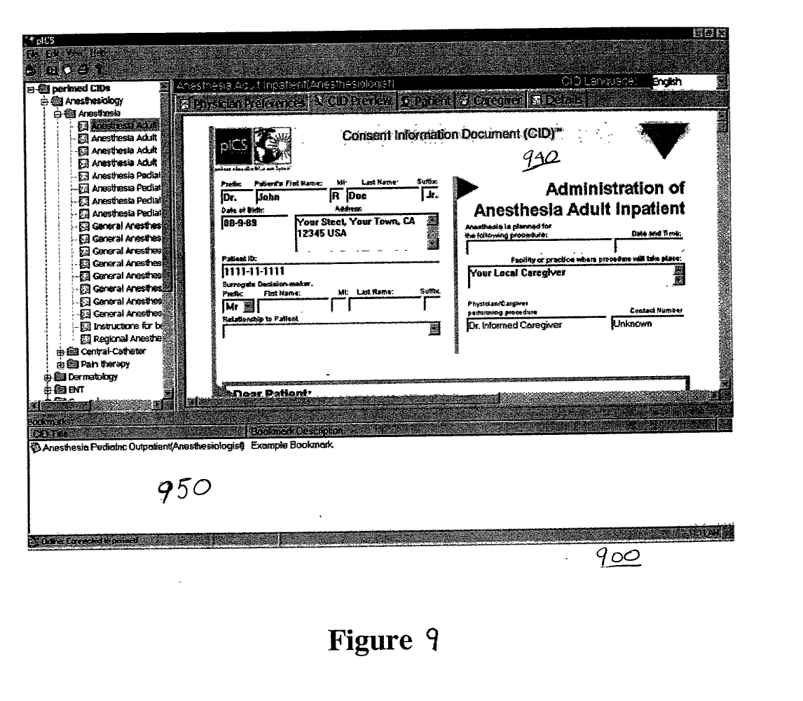

As seen in FIG. 9 which contains the same screen capture as displayed in FIG. 8, except the screen capture 900 includes the additional window 950 which indicates bookmarked files which have been accessed.

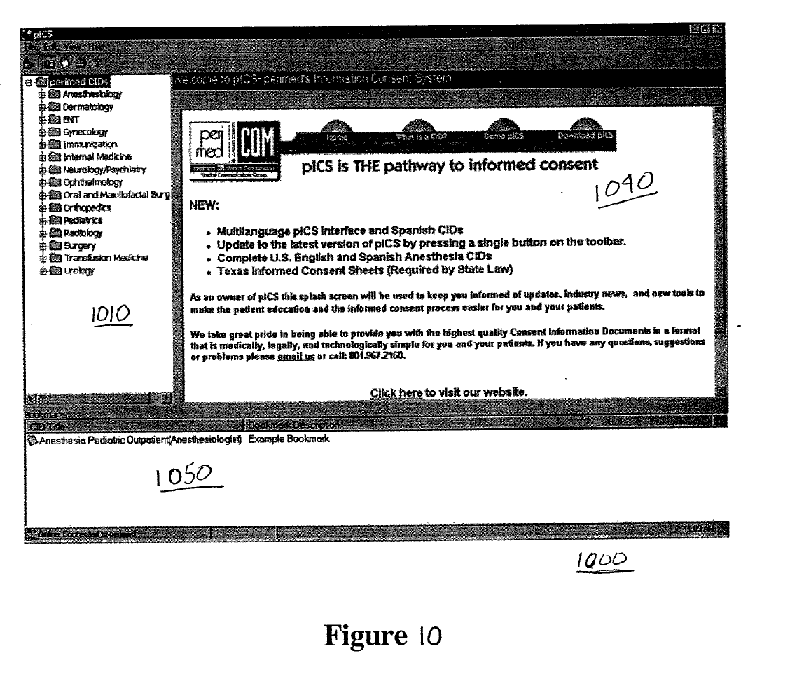

FIG. 10 represents a screen capture 1000 indicating a home page 1040 which is highlighted in the bookmark window 410 on the tree view, as previously described. The screen capture 1000 also includes the previously accessed files indicated in window 1050.

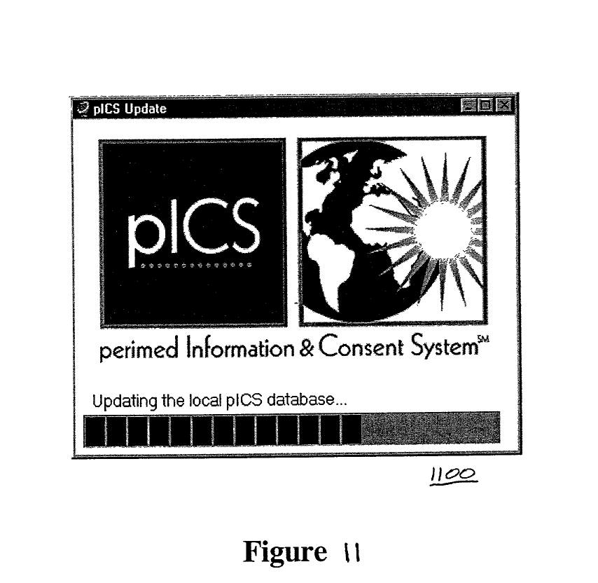

FIG. 11 illustrates a user interface screen used to provide status information to users while the local database is updated. Data kept locally may be stored in a database or as part of the file.

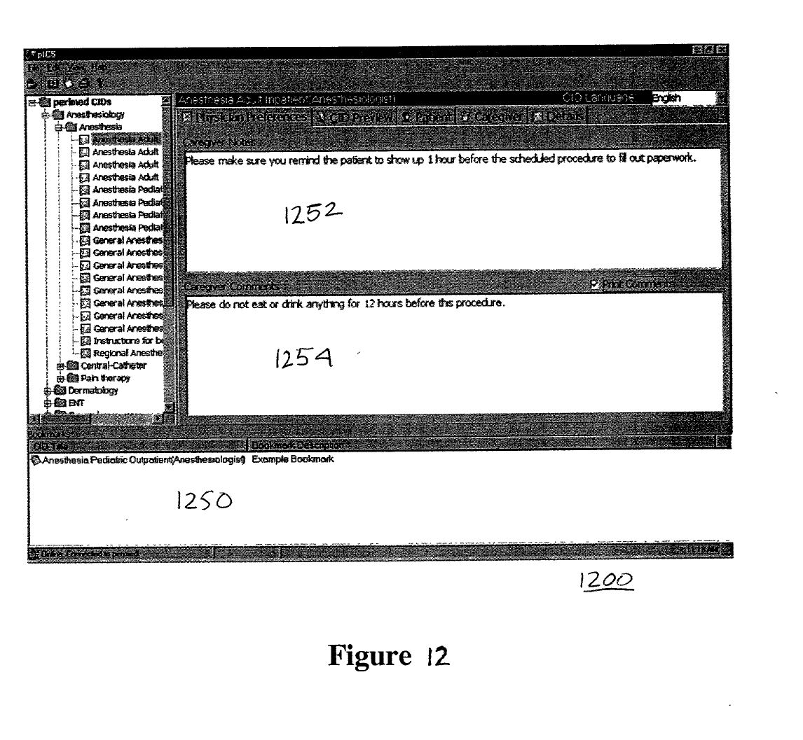

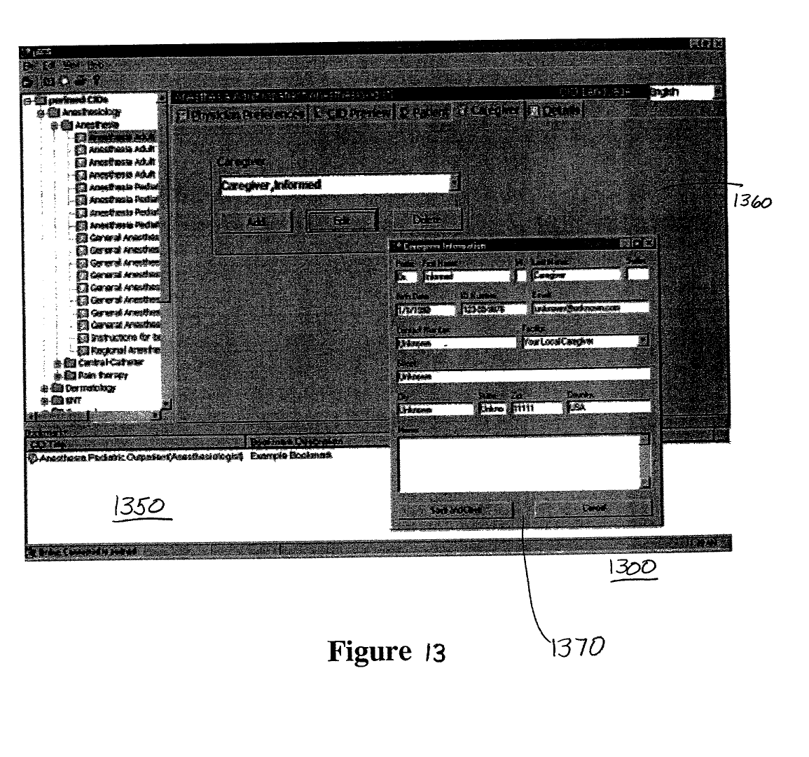

FIGS. 12 and 13 illustrate additional portions of a user interface available through the present invention. FIG. 12 illustrates an interface used to record notes and comments generated by a physician or other caregiver. As indicated in FIGS. 8 through 13, the user may select from the various tabs 822, 824, 826, 828, 830 to review or add information in a specific area. Under the physician preferences tab 822 a one can review caregiver notes in window 1252 or caregiver comments in window 1254. In addition, those with access to amend, edit or add text may do so through the user interface 1200. Therefore, a physician or caregiver may add appropriate text to the caregiver notes 1252 or caregiver comments 1254.

FIG. 13 specifically illustrates adding and editing caregiver or physician information. When the caregiver adds or edits information they access the caregiver tab 828, as seen in FIG. 8. Upon selecting the caregiver tab 828 the physician is provided screen 1360 in which they indicate the file within which they would like to edit or add comments. A separate screen 1370 is displayed in which the caregiver can edit and add information.

It can thus be seen that the present invention improves over the prior art by providing an intuitive, graphical interface to the underlying data. The present invention further improves upon the prior art by operating remotely across the Internet, including storing duplicate copies of files on a remote data warehouse, and receiving software updates and news of interest to users through the Internet. The present invention also builds upon the prior art by integrating with E-mail, accounting, and scheduling.

Further, the present invention may also include an outcome measurement system and a complications data collection system. The Outcomes Measurement System will consist of Internet enabled branching questionnaires for both the physician and the patient to complete on a pre-scheduled basis for a defined time period, for example 3 years, following each medical procedure in a given category. The responses to the questionnaires and other pertinent data related to the procedure will be collected, accumulated, analyzed and stored in a dedicated data repository.

The present invention may also employ a Complications Data Collection System which will consist of Internet enabled event and data recording tools which are able to document extraordinary events which occur during and after each medical procedure. The data from the Complications Data Collection System will be collected, accumulated, analyzed, and stored in a dedicated data repository.

Other applications for which the present invention may acquire and analyze data and or obtain patient consent would include Clinical trials informed consent, pharmaceutical usage informed consent, advanced directives instructions, certain versions of medical best practices, and a synopsis or questionnaire format procedure which may include notes records at or immediately after a surgical or diagnostic procedure.

The present invention provides a dynamic Internet enabled tool for the patient-physician Informed Consent Process, in which each medical consent form may be mass customized for the specific patient-physician relationship, and contain the actual historical record of medical complications and outcomes measures for each client physician or organization. The present invention provides a medical information system to record, analyze, retrieve and distribute actual or physician specific medical data on the fly from a data repository.

While the invention has been particularly shown and described with reference to a preferred embodiment thereof, it will be understood by those skilled in the art that various changes in form and details may be made therein without departing from the spirit and scope of the invention.

What is claimed is:

1. A system for archiving and retrieval of medical documents comprising:
an electronic device for accessing a database through a system server;
a software application loaded on at least one of said electronic device and said system server for providing a user interface, wherein said user interface includes a tree view file navigation; and
an Internet browser loaded on at least one of said electronic device and said system server for the transmission of at least one medical document file;
wherein said system server retrieves medical document files on said database and transmits said medical document files to said electronic device for display on said user interface.

2. The system of claim 1, wherein said software application is a CD installed and internet maintained application for a single computer.

3. The system of claim 1, wherein said software application is a CD installed and internet maintained application for a network of computers.

4. The system of claim 1, wherein said software application is an Application Service Provider application for a single computer.

5. The system of claim 1, wherein said software application is an Application Service Provider application for a network of computers.

6. The system of claim 1, wherein said electronic device is a personal computer.

7. The system of claim 1, wherein said electronic device is a personal digital assistant.

8. The system of claim 1, wherein said electronic device is a wireless phone.

9. The system of claim 1, wherein said electronic device is a beeper.

10. A method of archiving and retrieving medical documents comprising the steps of:
establishing a client computer to a system computer communication link;
selecting a medical document file from within a user interface provided as part of a software application;
determining which of said medical document files are stored on said client computer and which are stored on said system computer;
accessing said medical document file from said system computer;
transmitting said accessed medical document file to said client computer; and
displaying said medical document file on said user interface.

11. The method of claim 10, further comprising the step of selecting said medical document file using a tree view navigation through said user interface.

12. The method of claim 10, further comprising the step of establishing a communication link over the World Wide Web.

13. The method of claim 10, further comprising the step of accessing said medical document file for a patient's informed consent of medical treatment.

14. The method of claim 10, further comprising the step of printing said medical document file in a standard medical document format.

15. A system for archiving and retrieval of medical documents comprising:
an electronic device for accessing a database through a system server;
a software application for providing a user interface; and
an Internet for the transmission of at least one medical document file;
wherein said system server retrieves medical document files on said database and transmits said medical document files to said electronic device for display on said user interface.

16. The system of claim 15, wherein said software application is loaded on at least one of said system server and said electronic device.

17. The system of claim 15, wherein said Internet browser is loaded on at least one of said system server and said electronic device.

18. A method of providing informed consent for medical procedures via computer to computer communication comprising the steps of:
establishing a client computer to a system computer communication link;
selecting a medical document file from within a user interface provided as part of a software application, wherein said medicinal document file comprises a medical procedure informed consent document;
accessing said medical document file from at least one of said client computer or said system computer;
transmitting said accessed medical document file to said client computer;
displaying said medical document file on said user interface, whereby a patient can review said medical procedure informed consent document; and
archiving said patient review and acceptance of a medical treatment described in said medical procedure informed consent document.
